(19) United States
(12) Patent Application Publication
(10) Pub. No.: US 2026/0126696 A1
(43) Pub. Date: May 7, 2026

(54) VEHICULAR INTERIOR REARVIEW MIRROR ASSEMBLY WITH REMOTE AUTO-DIMMING CONTROLLER

(71) Applicant: Magna Mirrors of America, Inc., Holland, MI (US)

(72) Inventor: Austin T. Buerkle, Grand Rapids, MI (US)

(21) Appl. No.: 19/369,638

(22) Filed: Oct. 27, 2025

Related U.S. Application Data
(60) Provisional application No. 63/714,978, filed on Nov. 1, 2024.

(51) Int. Cl. G02F 1/163; B60R 1/04; B60R 1/08; B60R 1/12; B60R 16/023; H04N 7/18; H04N 23/21; H04N 23/57; H04N 23/66

(52) U.S. Cl. CPC G02F 1/163; B60R 1/04; B60R 1/088; B60R 1/12; B60R 1/1207; B60R 16/0231; H04N 7/183; H04N 23/21; H04N 23/57; H04N 23/66; B60R 2001/1253

(57) ABSTRACT

A vehicular cabin monitoring system includes a camera accommodated by a mirror head of an interior electrochromic rearview mirror assembly. The camera moves together and in tandem with the mirror head. The mirror head accommodates reflectivity-dimming circuitry operable to adjust dimming of a mirror reflective element of the mirror assembly and a serializer. An electronic control unit (ECU) is disposed at the vehicle remote from the mirror assembly and the mirror head is connected to the ECU via a coaxial cable. Image data captured by the camera is transferred to the ECU via the coaxial cable. A control signal for adjusting dimming of the mirror reflective element is transferred to the reflectivity-dimming circuitry from the ECU via the coaxial cable. Power is transferred to the mirror head via the coaxial cable.

### CROSS REFERENCE TO RELATED APPLICATION

The present application claims the filing benefits of U.S. provisional application Ser. No. 63/714,978, filed Nov. 1, 2024, which is hereby incorporated herein by reference in its entirety.

### FIELD OF THE INVENTION

The present invention relates generally to the field of interior rearview mirror assemblies for vehicles.

### BACKGROUND OF THE INVENTION

It is known to provide a mirror assembly that is adjustably mounted to an interior portion of a vehicle, such as via a double ball pivot or joint mounting configuration where the mirror head and reflective element are adjusted relative to the interior portion of a vehicle by pivotal movement about the double ball pivot configuration. The mirror head and reflective element are pivotable about either or both of the ball pivot joints by a user that is adjusting the user's rearward view.

### SUMMARY OF THE INVENTION

A cabin monitoring system includes a vehicular interior electrochromic rearview mirror assembly including a mirror head adjustable about a mounting structure. The mounting structure is configured to mount the vehicular interior electrochromic rearview mirror assembly at an interior portion of an interior cabin of a vehicle. The mirror head accommodates an electrochromic mirror reflective element. A cabin monitoring camera is accommodated by the mirror head, and the cabin monitoring camera moves together and in tandem with the mirror head when, with the vehicular interior electrochromic rearview mirror assembly mounted at the interior portion of the interior cabin of the vehicle, the mirror head is adjusted relative to the mounting structure to set a rearward view of a driver of the vehicle. The mirror head accommodates a printed circuit board (PCB) having (i) a serializer and (ii) auto-dimming driver circuitry operable to adjust dimming of the electrochromic mirror reflective element. An electronic control unit (ECU) is disposed at the vehicle remote from the vehicular interior electrochromic rearview mirror assembly. Image data captured by the cabin monitoring camera is transferred to the ECU. The ECU includes electronic circuitry and associated software, and the electronic circuitry of the ECU includes an image processor operable to process image data transferred to the ECU. The auto-dimming driver circuitry adjusts dimming of the electrochromic mirror reflective element responsive to receiving a control signal. With the vehicular interior electrochromic rearview mirror assembly mounted at the interior portion of the interior cabin of the vehicle, the control signal is transferred to the auto-dimming driver circuitry from the ECU. With the vehicular interior electrochromic rearview mirror assembly mounted at the interior portion of the interior cabin of the vehicle, the mirror head is electrically connected to the ECU via a coax cable. With the vehicular interior electrochromic rearview mirror assembly mounted at the interior portion of the interior cabin of the vehicle, (i) power is transferred to the mirror head via the coax cable, (ii) the control signal is transferred to the auto-dimming driver circuitry from the ECU via the coax cable and (iii) image data is transferred from the serializer to the ECU via the coax cable. The coax cable may provide a complete power-over-coax connection for power and data transfer between the mirror head and the vehicle ECU. With the vehicular interior electrochromic rearview mirror assembly mounted at the interior portion of the interior cabin of the vehicle image data captured by the cabin monitoring camera is processed at the ECU for at least one of (i) a driver monitoring function and (ii) an occupant monitoring function.

These and other objects, advantages, purposes and features of the present invention will become apparent upon review of the following specification in conjunction with the drawings.

### BRIEF DESCRIPTION OF THE DRAWINGS

FIG. 1 is a perspective view of an interior rearview mirror assembly;

FIG. 2 is a sectional view of the mirror reflective element of the mirror assembly;

FIG. 3 is a schematic diagram of the mirror assembly connected via a coax cable to a controller at the vehicle and remote from the mirror assembly, with the mirror assembly having an ambient light sensor and a glare light sensor; and

FIG. 4 is another schematic diagram of the mirror assembly connected via the coax cable to the remote controller, with the mirror assembly not including the ambient light sensor or the glare light sensor.

### DESCRIPTION OF THE PREFERRED EMBODIMENTS

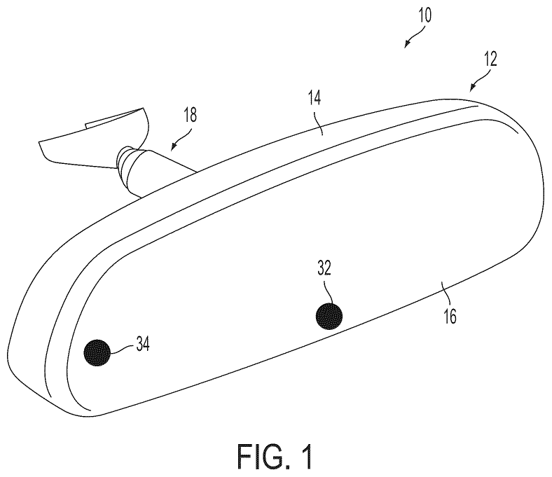

Referring now to the drawings and the illustrative embodiments depicted therein, a vehicular interior rearview mirror assembly 10 includes a mirror head 12 that includes a casing 14 and a reflective element 16 positioned at a front portion of the casing 14 (FIG. 1). In the illustrated embodiment, the mirror assembly 10 is configured to be adjustably mounted to an interior portion of a vehicle (such as to an interior or in-cabin surface of a vehicle windshield or a headliner of a vehicle or the like) via a mounting structure or mounting configuration or assembly 18. The mirror reflective element includes a variable reflectance mirror reflective element that varies its reflectance responsive to electrical current applied to conductive coatings or layers of the reflective element.

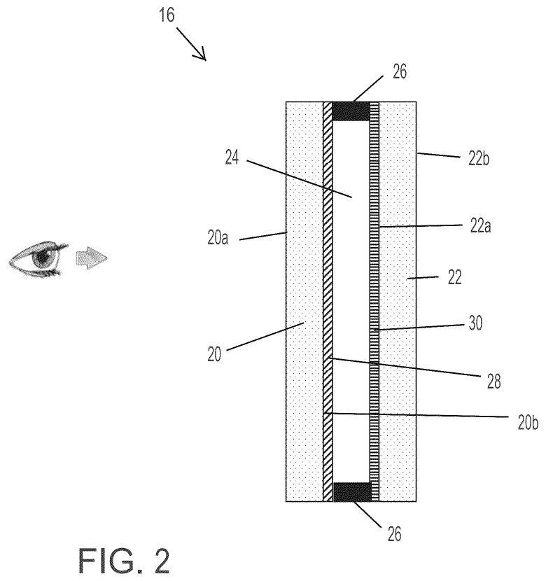

In the illustrated embodiment, and as shown in FIG. 2, the mirror reflective element 16 comprises a laminate construction variable reflectance electro-optic (such as electrochromic) reflective element assembly having a front substrate 20 and a rear substrate 22 with an electro-optic medium 24 (such as electrochromic medium) sandwiched therebetween and bounded by a main seal or perimeter seal 26. As shown in FIG. 2, the front substrate 20 has a front or first surface 20a (the surface that generally faces the driver of a vehicle when the mirror assembly is normally mounted at the vehicle) and a rear or second surface 20b opposite the front surface 20a, and the rear substrate 22 has a front or third surface 22a and a rear or fourth surface 22b opposite the front surface 22a, with the electro-optic medium 24 disposed between the second surface 20b and the third surface 22a and bounded by the perimeter seal 26 of the reflective element. The second surface 20b of the front glass substrate 20 has a transparent conductive coating 28 established thereat (such as an indium tin oxide (ITO) layer, or a doped tin oxide layer or any other transparent electrically semi-conductive layer or coating or the like (such as indium cerium oxide (ICO), indium tungsten oxide (IWO), or indium oxide (IO) layers or the like or a zinc oxide layer or coating, or a zinc oxide coating or the like doped with aluminum or other metallic materials, such as silver or gold or the like, or other oxides doped with a suitable metallic material or the like, or such as disclosed in U.S. Pat. No. 7,274,501, which is hereby incorporated herein by reference in its entirety), while the third surface 22a of the rear glass substrate 22 has a metallic reflector coating 30 (or multiple layers or coatings) established thereat. The front or third surface 22a of the rear substrate 22 may include one or more transparent semi-conductive layers (such as an ITO layer or the like), and one or more metallic electrically conductive layers (such as a layer of silver, aluminum, chromium or the like or an alloy thereof), and may include multiple layers such as disclosed in U.S. Pat. Nos. 7,274,501; 7,184,190 and/or 7,255,451, which are hereby incorporated herein by reference in their entireties. The mirror reflector may comprise any suitable coatings or layers, such as a transflective coating or layer, such as described in U.S. Pat. Nos. 7,626,749; 7,274,501; 7,255,451; 7,195,381; 7,184,190; 6,690,268; 5, 140,455; 5,151,816; 6,178,034; 6,154,306; 6,002,511; 5,567,360; 5,525,264; 5,610,756; 5,406,414; 5,253,109; 5,076,673; 5,073,012; 5,115,346; 5,724,187; 5,668,663; 5,910,854; 5,142,407 and/or 4,712,879, which are hereby incorporated herein by reference in their entireties, disposed at the front surface of the rear substrate (commonly referred to as the third surface of the reflective element) and opposing the electro-optic medium, such as an electrochromic medium disposed between the front and rear substrates and bounded by the perimeter seal (but optionally, the mirror reflector could be disposed at the rear surface of the rear substrate (commonly referred to as the fourth surface of the reflective element).

The third surface 22a defines the active EC area or surface of the rear substrate within the perimeter seal 26. The coated third surface 22a may also be coated to define a tab-out region (such as by utilizing aspects of the mirror assemblies described in U.S. Pat. Nos. 7,274,501; 7,184,190 and/or 7,255,451, which are hereby incorporated herein by reference in their entireties) for providing electrical connection of the conductive layers to an electrical clip of connector or bus-bar, such as the types described in U.S. Pat. Nos. 5,066,112 and 6,449,082, which are hereby incorporated herein by reference in their entireties.

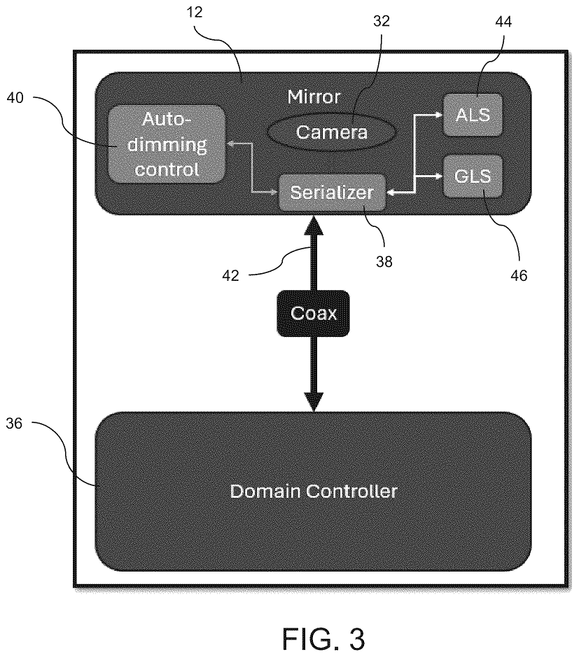

The mirror assembly 10 includes or is associated with a driver monitoring system (DMS) and/or an occupant monitoring system (OMS), with the mirror assembly including a driver/occupant monitoring camera 32 disposed at a back plate (and viewing through an aperture of the back plate) behind the reflective element 16 and viewing through the reflective element 16 toward at least a head region of the driver of the vehicle (FIG. 1). The DMS may include an infrared light (IR light) or near infrared light (near IR light) emitter 34 disposed at the back plate and emitting IR light or near IR light that passes through another aperture of the back plate and through the reflective element 16. As discussed further below, image data captured by the DMS/OMS camera 32 is transferred to an electronic controller (ECU) 36 disposed remote from the mirror head 12 (e.g., a vehicle domain controller), such as via a coaxial cable 42 (FIG. 3). The ECU 36 has electronic circuitry and associated software, including an image processor for processing the image data captured by the DMS/OMS camera. Image data captured by the camera may be processed at the ECU for a head and face direction and position tracking system and/or eye tracking system and/or gesture recognition system.

As shown in FIG. 3, the mirror head 12 accommodates a serializer 38 and image data captured by the camera 32 is transferred to the remote ECU 36 via the serializer 38 and coaxial cable 42 to be processed for the DMS/OMS function. Moreover, the mirror head 12 accommodates auto-dimming control circuitry or a driver 40 for adjusting dimming of the electro-optic mirror reflective element 16. The auto-dimming driver 40 operates to adjust dimming of the mirror reflective element 16 based on control signals received from the remote ECU 36 via the serializer 38. For example, the mirror head 12 may accommodate a printed circuit board (PCB) and the serializer 38 and the auto-dimming driver 40 may both be disposed on the PCB.

The mirror head 12 may be connected to the ECU via a coax cable 42 and the coax cable 42 may provide the only connection between the mirror head 12 and the ECU. In other words, the mirror head 12 utilizes power-over-coax (POC) cable to power the DMS/OMS camera 32 and the auto-dimming driver 40 and to transfer captured image data from the camera 32 to the remote ECU 36 and to transfer control signals from the remote ECU 36 to the auto-dimming driver 40. The coaxial cable provides bi-directional communication between the ECU and the mirror head. The coaxial cable and electronic connection between the ECU and the mirror head may utilize aspects of the systems described in U.S. Pat. Nos. 10,567,705; 10,298,823; 10,099,614; 10,089,537; 9,900,490 and/or 9,609,757, which are hereby incorporated herein by reference in their entireties. Thus, the bi-directional coaxial cable may commonly carry (i) image data captured by the DMS camera from the mirror head to the ECU, (ii) control signals from the ECU to the mirror head (such as for controlling the camera and/or a light emitter and/or dimming circuitry of the mirror head), and (iii) electrical power from a DC power supply of (or connected to) the ECU to the mirror head.

Dimming of the mirror reflective element 16 is operated based on an ambient light level at or near the mirror assembly and/or based on detection of glare light emanating from a light source rearward of the vehicle and incident at the mirror reflective element (e.g., from another vehicle behind the equipped vehicle). For example, the mirror head 12 may accommodate an ambient light sensor 44 for capturing sensor data representative of the level of ambient light at or near the mirror head 12 and/or a glare light sensor 46 for detecting glare light at the mirror reflective element 16 (e.g., that emanates from a trailing vehicle traveling along the road behind the equipped vehicle). The ambient light sensor 44 and the glare light sensor 46 may transfer captured sensor data to the remote ECU 36 over the coax cable 42 via the serializer 38. Determination of the ambient light level and/or detection of the glare light may occur at the remote ECU 36 based on processing of the captured sensor data. Responsive to the determined level of ambient light and/or responsive to detection of glare light incident at the mirror reflective element 16, the control signal for adjusting dimming of the mirror reflective element 16 is transferred from the ECU 36 to the auto-dimming driver 40 over the coax cable 42 via the serializer 38.

Thus, the interior rearview mirror assembly 10 accommodates the DMS/OMS camera 32 and/or near IR light emitters 34 within the mirror head 12. The mirror head 12 may further accommodate the ambient light sensor 44 and the glare light sensor 46 and dimming of the mirror reflective element 16 may be adjusted based on sensor data captured by the ambient light sensor 44 and the glare light sensor 46. Image data captured by the camera 32 and sensor data captured by the ambient light sensor 44 and the glare light sensor 46 is transferred to the ECU 36 remote from the mirror head 12 via the power-over-coax connection. Further, the remote ECU 36 transfers control signals to the auto-dimming driver 40 via the power-over-coax connection. The coax 42 may connect to the serializer 38 for transferring sensor data and/or control signals between the mirror head 12 and the remote ECU 36. Consolidating processing of the DMS image data and ambient light and/or glare light sensor data at the remote ECU 36 reduces the thermal load at the mirror head 12 and allows the mirror head to connect to the vehicle ECU via the singular coax connection 42.

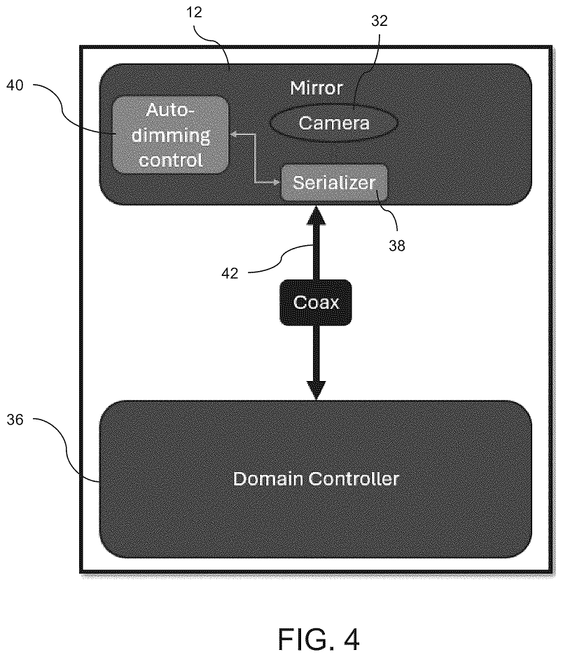

Optionally, and such as shown in FIG. 4, the mirror head 12 may not accommodate glare light or ambient light sensors and the image data captured by the DMS camera 32 may be processed at the remote ECU 36 for determining the level of ambient light at or near the mirror head and for detecting glare light incident at the mirror reflective element 16. Thus, the image data is transferred to the remote ECU 36 via the serializer 38 for both the DMS/OMS function and for controlling dimming of the mirror reflective element 16.

Moreover, the ECU 36 may transfer DMS/OMS control signals to the mirror head 12 via the coaxial cable 42 to adjust operation of the camera 32 and/or light emitters 34.

That is, based on processing of the image data captured by the camera 32, the ECU 36 may transfer the DMS/OMS control signals, such as to adjust intensity of light emitted by the light emitters 34, to adjust a pulse rate of the light emitters 34, to adjust camera parameters (e.g., white balance, exposure time, etc.) to adjust image data captured by the camera 32, and the like. For example, based on determination that the driver is not visible in the captured image data (e.g., due to low ambient light levels within the cabin), the DMS/OMS may turn on or increase the intensity of light emitted by the IR light emitters 34 to improve illumination of the driver.

In other words, with the mirror-based driver monitoring system, all power and data is supplied/transferred by the coax cable 42 using power-over-coax. The mirror has an auto-dimming feature which also supplies power and signals via the same coax cable 42. The auto-dimming drive circuit 40 may be placed on the serializer PCB rather than requiring a separate, unique PCB. For the DMS function, the camera 32 and IR LEDs 34 for illuminating the driver may all be contained within the interior mirror. The IR LEDs 34 may illuminate the driver, and the camera sends image data to the domain controller 36 via a video serializer 38 and coax cable 42. The domain controller 36 may adjust operation of the camera 32 and/or LEDs 34 via signals sent via the coax cable 42. For the auto-dimming function, either light sensor data or camera data is sent to the domain controller 36, it calculates the appropriate pulse width modulation (PWM) signal and that PWM signal is sent back to the mirror auto-dimming circuit 40 via the serializer/deserializer (SerDes) 38 general purpose input/output (GPIO).

A benefit is that the system does not require both a wire-harness and a coax cable to be run to the mirror location in the vehicle as a single coax cable may be run to the mirror location for power and data transfer, simplifying the vehicle wire harness. The integration of the auto-dimming electronics on the Serializer PCB also allows for the removal of a dedicated auto-dimming PCBA from the mirror assembly. This also takes advantage of the computing power in the domain controller, eliminating the need for a dedicated microcontroller for the auto-dimming function inside the mirror. In some examples, this system may also leverage the camera information to perform the same function as the two dedicated light sensors, eliminating the need for dedicated light sensors inside the mirror.

This simplifies the vehicle architecture, leverages existing sensors and computing power to perform additional functions rather than requiring duplicate or additional computing power or sensors, and reduces the cost of the inside mirror with the removal of a microcontroller and potentially light sensors. Additional savings can be found by leveraging the existing power supplies required for the DMS function, eliminating the need for a dedicated supply for the auto-dimming function. This also eliminates the need for an internal mirror wire harness. This improves on typical architectures that require the additional sensors and microcontrollers inside the mirror to perform the auto-dimming function. Moreover, the system creates a more competitive product from a business perspective and simplifies the physical architecture. For example, only a coax cable is routed to the mirror location to provide a DMS mirror. There is no need to route additional wires to the mirror for other functions like power, ground, LIN/vehicle communications. This could also aid in production because only one coax cable needs to be connected, rather than a coax cable and an additional wire harness connector. A portable and hardware-independent algorithm may be used for calculating outputs for the auto-dimming function.

The DMS camera thus may be used to detect ambient light and/or glare light (emanating from headlamps of a trailing vehicle) for use in providing auto-dimming of the EC mirror reflective element. The processing of image data captured by the DMS camera may be adjusted to accommodate the angle of the mirror head so that the ECU or system, via image processing of image data captured by the DMS camera, determines headlamps of a trailing vehicle (behind the equipped vehicle and traveling in the same direction as the equipped vehicle and traveling in the same traffic lane or in an adjacent traffic lane) to determine glare light incident at the mirror reflective element. Optionally, image data captured by another rearward-viewing camera, such as a rear backup camera of the vehicle or a higher-mounted (e.g., CHMSL mounted) rearward-viewing camera at or near a center high-mounted stop lamp of the vehicle, may be processed for determining ambient light and glare light. The processing of image data captured by the DMS camera is adjusted to accommodate the degree of dimming of the mirror reflective element. For example, the system knows how much the mirror reflective element is dimmed (responsive to the determined glare light intensity and location) and can accommodate for the mirror dimming level when processing captured image data to determine presence and intensity of light sources/headlamps rearward of the vehicle. The intelligent/automatic mirror dimming functions may utilize aspects of the systems described in U.S. Pat. Nos. 11,780,372; 11,242,008; 10,967,796 and/or 10,948,798, and/or U.S. Publication No. US-2024-0064274, which are all hereby incorporated herein by reference in their entireties.

The interior mirror assembly may comprise a dual-mode interior rearview video mirror that can switch from a traditional reflection mode to a live-video display mode, such as is by utilizing aspects of the mirror assemblies and systems described in U.S. Pat. Nos. 11,242,008; 11,214,199; 10,442,360; 10,421,404; 10,166,924; 10,046,706 and/or 10,029,614, and/or U.S. Publication Nos. US-2024-0064274; US-2021-0162926; US-2021-0155167; US-2020-0377022; US-2019-0258131; US-2019-0146297; US-2019-0118717 and/or US-2017-0355312, which are all hereby incorporated herein by reference in their entireties. The video display screen of the video mirror, when the mirror is in the display mode, may display video images derived from video image data captured by a rearward viewing camera, such as a rearward camera disposed at a center high-mounted stop lamp (CHMSL) location, and/or video image data captured by one or more other cameras at the vehicle, such as side-mounted rearward viewing cameras or the like, such as by utilizing aspects of the display systems described in U.S. Pat. No. 11,242,008, which is hereby incorporated herein by reference in its entirety. The operating mode of the mirror and video display screen may be selected by flipping the mirror head upward or downward (e.g., via a toggle located at the mirror head) or responsive to another user input. When the mirror is operating in the mirror mode, the video display screen is deactivated and rendered covert by the mirror reflective element, and the driver views rearward via reflection of light incident at the mirror reflective element. When the mirror is operating in the display mode, the video display screen is operated to display video images that are viewable through the mirror reflective element by the driver of the vehicle.

The driver monitoring system and/or head and face direction and position tracking system and/or eye tracking system and/or gesture recognition system may utilize aspects of the systems described in U.S. Pat. Nos. 11,827,153; 11,780,372; 11,639,134; 11,582,425; 11,518,401; 10,958,830; 10,065,574; 10,017,114; 9,405,120 and/or 7,914,187, and/or U.S. Publication Nos. US-2024-0383406; US-2024-0190456; US-2024-0168355; US-2022-0377219; US-2022-0254132; US-2022-0242438; US-2021-0323473; US-2021-0291739; US-2020-0320320; US-2020-0202151; US-2020-0143560; US-2019-0210615; US-2018-0231976; US-2018-0222414; US-2017-0274906; US-2017-0217367; US-2016-0209647; US-2016-0137126; US-2015-0352953; US-2015-0296135; US-2015-0294169; US-2015-0232030; US-2015-0092042; US-2015-0022664; US-2015-0015710; US-2015-0009010 and/or US-2014-0336876, and/or U.S. patent application Ser. No. 19/290,465, filed Aug. 5, 2025 (Attorney Docket DON01 P5440), and/or International Publication No. WO 2023/220222 and/or International Patent Application Ser. No. PCT/US 25/27206, filed May 1, 2025 (Attorney Docket MAG04 FP5372WO) and/or International Patent Application No. PCT/US25/038021, filed Jul. 17, 2025 (Attorney Docket MAG04 FP5398WO), which are all hereby incorporated herein by reference in their entireties.

The interior-viewing camera may be disposed at the mirror head of the interior rearview mirror assembly and moves together and in tandem with the mirror head when the driver of the vehicle adjusts the mirror head to adjust his or her rearward view. The interior-viewing camera may be disposed at a lower or chin region of the mirror head below the mirror reflective element of the mirror head, or the interior-viewing camera may be disposed behind the mirror reflective element and viewing through the mirror reflective element. Similarly, the light emitter may be disposed at the lower or chin region of the mirror head below the mirror reflective element of the mirror head (such as to one side or the other of the interior-viewing camera), or the light emitter may be disposed behind the mirror reflective element and emitting light that passes through the mirror reflective element. The ECU may be disposed elsewhere in the vehicle remote from the mirror assembly, whereby image data captured by the interior-viewing camera may be transferred to the ECU via a coaxial cable or other suitable communication line. Cabin monitoring or occupant detection may be achieved via processing at the ECU of image data captured by the interior-viewing camera. Optionally, cabin monitoring or occupant detection may be achieved in part via processing at the ECU of radar data captured by one or more interior-sensing radar sensors disposed within the vehicle and sensing the interior cabin of the vehicle.

Optionally, the driver monitoring system may be integrated with a camera monitoring system (CMS) of the vehicle. The integrated vehicle system incorporates multiple inputs, such as from the inward viewing or driver monitoring camera and from the forward or outward viewing camera, as well as from a rearward viewing camera and sideward viewing cameras of the CMS (e.g., a rearward-viewing camera disposed at the rear of the vehicle remote from the rear backup camera of the vehicle, and rearward-viewing cameras disposed at respective sides of the vehicle, such as at respective side-mounted exterior rearview mirror assemblies of the vehicle), to provide the driver with unique collision mitigation capabilities based on full vehicle environment and driver awareness state. The image processing and detections and determinations are performed locally within the interior rearview mirror assembly and/or the overhead console region, depending on available space and electrical connections for the particular vehicle application. The CMS cameras and system may utilize aspects of the systems described in U.S. Pat. No. 11,242,008 and/or U.S. Publication Nos. US-2024-0064274; US-2021-0245662; US-2021-0162926; US-2021-0155167; US-2018-0134217 and/or US-2014-0285666, which are all hereby incorporated herein by reference in their entireties.

The ECU may receive image data captured by a plurality of cameras of the vehicle, such as by a plurality of surround view system (SVS) cameras and a plurality of camera monitoring system (CMS) cameras and optionally one or more driver monitoring system (DMS) cameras. The ECU may comprise a central or single ECU that processes image data captured by the cameras for a plurality of driving assist functions and may provide display of different video images to a video display screen in the vehicle (such as at an interior rearview mirror assembly or at a central console or the like) for viewing by a driver of the vehicle. The system may utilize aspects of the systems described in U.S. Pat. Nos. 11,242,008; 10,442,360 and/or 10,046,706, and/or U.S. Publication Nos. US-2024-0064274; US-2021-0245662; US-2021-0162926; US-2021-0155167 and/or US-2019-0118717, which are all hereby incorporated herein by reference in their entireties.

The camera includes a lens and imaging sensor. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or pixels or at least two million photosensor elements or at least three million photosensor elements or pixels or at least five million photosensor elements or pixels arranged in rows and columns. The imaging array may be sensitive to near-infrared light. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

Changes and modifications in the specifically described embodiments may be carried out without departing from the principles of the present invention, which is intended to be limited only by the scope of the appended claims as interpreted according to the principles of patent law.

1. A vehicular cabin monitoring system, the vehicular cabin monitoring system comprising:
a vehicular interior electrochromic rearview mirror assembly comprising a mirror head adjustable about a mounting structure, wherein the mounting structure is configured to mount the vehicular interior electrochromic rearview mirror assembly at an interior portion of an interior cabin of a vehicle;
wherein the mirror head accommodates an electrochromic mirror reflective element;
a cabin monitoring camera accommodated by the mirror head, wherein the cabin monitoring camera moves together and in tandem with the mirror head when, with the vehicular interior electrochromic rearview mirror assembly mounted at the interior portion of the interior cabin of the vehicle, the mirror head is adjusted relative to the mounting structure to set a rearward view provided by the electrochromic mirror reflective element for a driver of the vehicle;
wherein the mirror head accommodates (i) reflectivity-dimming circuitry operable to adjust dimming of the electrochromic mirror reflective element and (ii) a serializer;
an electronic control unit (ECU) disposed at the vehicle remote from the vehicular interior electrochromic rearview mirror assembly;
wherein, with the vehicular interior electrochromic rearview mirror assembly mounted at the interior portion of the interior cabin of the vehicle, the mirror head is electrically connected to the ECU via a coaxial cable;
wherein image data captured by the cabin monitoring camera is transferred to the ECU via the coaxial cable;
wherein the ECU comprises electronic circuitry and associated software, and wherein the electronic circuitry of the ECU comprises an image processor operable to process image data transferred to the ECU;
wherein the reflectivity-dimming circuitry adjusts dimming of the electrochromic mirror reflective element responsive to receiving a control signal, and wherein, with the vehicular interior electrochromic rearview mirror assembly mounted at the interior portion of the interior cabin of the vehicle, the control signal is transferred from the ECU to the reflectivity-dimming circuitry via the coaxial cable;
wherein, with the vehicular interior electrochromic rearview mirror assembly mounted at the interior portion of the interior cabin of the vehicle, power is transferred to the mirror head from the ECU via the coaxial cable; and
wherein, with the vehicular interior electrochromic rearview mirror assembly mounted at the interior portion of the interior cabin of the vehicle, image data captured by the cabin monitoring camera and transferred to the ECU via the coaxial cable is processed at the ECU for at least one selected from the group consisting of (i) a driver monitoring function and (ii) an occupant monitoring function.

2. The vehicular cabin monitoring system of claim 1, wherein the ECU generates the control signal based on at least one selected from the group consisting of (i) a determined level of ambient light at the interior cabin of the vehicle and (ii) determination of glare light incident at the electrochromic mirror reflective element.

3. The vehicular cabin monitoring system of claim 2, wherein the mirror head accommodates an ambient light sensor, and wherein sensor data captured by the ambient light sensor is transferred to the ECU via the coaxial cable and is processed at the ECU to determine the level of ambient light at the interior cabin of the vehicle.

4. The vehicular cabin monitoring system of claim 2, wherein the mirror head accommodates a glare light sensor, and wherein sensor data captured by the glare light sensor is transferred to the ECU via the coaxial cable and is processed at the ECU to determine glare light incident at the electrochromic mirror reflective element.

5. The vehicular cabin monitoring system of claim 2, wherein image data captured by the cabin monitoring camera and transferred to the ECU via the coaxial cable is processed at the ECU for the at least one selected from the group consisting of (i) determination of the level of ambient light at the interior cabin of the vehicle and (ii) determination of glare light incident at the electrochromic mirror reflective element.

6. The vehicular cabin monitoring system of claim 1, wherein the control signal comprises a pulse width modulation (PWM) signal.

7. The vehicular cabin monitoring system of claim 1, wherein the coaxial cable comprises the only electrical connection between the vehicular interior electrochromic rearview mirror assembly and the ECU.

8. The vehicular cabin monitoring system of claim 1, wherein the mirror head accommodates a printed circuit board (PCB), and wherein the serializer and the reflectivity-dimming circuitry are disposed at the PCB.

9. The vehicular cabin monitoring system of claim 1, wherein the mirror head accommodates a near infrared light emitter, and wherein, with the vehicular interior electrochromic rearview mirror assembly mounted at the interior portion of the interior cabin of the vehicle, the near infrared light emitter is electrically operable to emit near infrared light that illuminates at least a portion of the interior cabin of the vehicle, and wherein the cabin monitoring camera is operable to capture image data representative of near infrared light reflected from objects within the interior cabin of the vehicle.

10. The vehicular cabin monitoring system of claim 9, wherein, responsive to processing image data captured by the cabin monitoring camera and transferred to the ECU via the coaxial cable at the ECU, the vehicular cabin monitoring system adjusts operation of the near infrared light emitter to adjust near infrared light emitted by the near infrared light emitter.

11. The vehicular cabin monitoring system of claim 10, wherein cabin monitoring control signals are transferred from the ECU to the mirror head via the coaxial cable to adjust operation of the near infrared light emitter.

12. The vehicular cabin monitoring system of claim 1, wherein camera control signals are transferred from the ECU to the cabin monitoring camera via the coaxial cable to control operation of the cabin monitoring camera.

13. A vehicular cabin monitoring system, the vehicular cabin monitoring system comprising:
a vehicular interior electrochromic rearview mirror assembly comprising a mirror head adjustable about a mounting structure, wherein the mounting structure is configured to mount the vehicular interior electrochromic rearview mirror assembly at an interior portion of an interior cabin of a vehicle;
wherein the mirror head accommodates an electrochromic mirror reflective element;
a cabin monitoring camera accommodated by the mirror head, wherein the cabin monitoring camera moves together and in tandem with the mirror head when, with the vehicular interior electrochromic rearview mirror assembly mounted at the interior portion of the interior cabin of the vehicle, the mirror head is adjusted relative to the mounting structure to set a rearward view provided by the electrochromic mirror reflective element for a driver of the vehicle;
wherein the mirror head accommodates (i) reflectivity-dimming circuitry operable to adjust dimming of the electrochromic mirror reflective element and (ii) a serializer;
an electronic control unit (ECU) disposed at the vehicle remote from the vehicular interior electrochromic rearview mirror assembly;
wherein, with the vehicular interior electrochromic rearview mirror assembly mounted at the interior portion of the interior cabin of the vehicle, the mirror head is electrically connected to the ECU via a coaxial cable;
wherein the coaxial cable comprises the only electrical connection between the vehicular interior electrochromic rearview mirror assembly and the ECU;
wherein image data captured by the cabin monitoring camera is transferred to the ECU via the coaxial cable;
wherein the ECU comprises electronic circuitry and associated software, and wherein the electronic circuitry of the ECU comprises an image processor operable to process image data transferred to the ECU;
wherein camera control signals are transferred from the ECU to the cabin monitoring camera via the coaxial cable to control operation of the cabin monitoring camera;
wherein the reflectivity-dimming circuitry adjusts dimming of the electrochromic mirror reflective element responsive to receiving a control signal, and wherein, with the vehicular interior electrochromic rearview mirror assembly mounted at the interior portion of the interior cabin of the vehicle, the control signal is transferred from the ECU to the reflectivity-dimming circuitry via the coaxial cable, and wherein the control signal comprises a pulse width modulation (PWM) signal;
wherein, with the vehicular interior electrochromic rearview mirror assembly mounted at the interior portion of the interior cabin of the vehicle, power is transferred to the mirror head from the ECU via the coaxial cable; and
wherein, with the vehicular interior electrochromic rearview mirror assembly mounted at the interior portion of the interior cabin of the vehicle, image data captured by the cabin monitoring camera and transferred to the ECU via the coaxial cable is processed at the ECU for at least one selected from the group consisting of (i) a driver monitoring function and (ii) an occupant monitoring function.

14. The vehicular cabin monitoring system of claim 13, wherein the mirror head accommodates a printed circuit board (PCB), and wherein the serializer and the reflectivity-dimming circuitry are disposed at the PCB.

15. The vehicular cabin monitoring system of claim 13, wherein the mirror head accommodates a near infrared light emitter, and wherein, with the vehicular interior electrochromic rearview mirror assembly mounted at the interior portion of the interior cabin of the vehicle, the near infrared light emitter is electrically operable to emit near infrared light that illuminates at least a portion of the interior cabin of the vehicle, and wherein the cabin monitoring camera is operable to capture image data representative of near infrared light reflected from objects within the interior cabin of the vehicle.

16. The vehicular cabin monitoring system of claim 15, wherein, responsive to processing image data captured by the cabin monitoring camera and transferred to the ECU via the coaxial cable at the ECU, the vehicular cabin monitoring system adjusts operation of the near infrared light emitter to adjust near infrared light emitted by the near infrared light emitter, and wherein cabin monitoring control signals are transferred from the ECU to the mirror head via the coaxial cable to adjust operation of the near infrared light emitter.

17. A vehicular cabin monitoring system, the vehicular cabin monitoring system comprising:
a vehicular interior electrochromic rearview mirror assembly comprising a mirror head adjustable about a mounting structure, wherein the mounting structure is configured to mount the vehicular interior electrochromic rearview mirror assembly at an interior portion of an interior cabin of a vehicle;
wherein the mirror head accommodates an electrochromic mirror reflective element;
a cabin monitoring camera accommodated by the mirror head, wherein the cabin monitoring camera moves together and in tandem with the mirror head when, with the vehicular interior electrochromic rearview mirror assembly mounted at the interior portion of the interior cabin of the vehicle, the mirror head is adjusted relative to the mounting structure to set a rearward view provided by the electrochromic mirror reflective element for a driver of the vehicle;
wherein the mirror head accommodates (i) reflectivity-dimming circuitry operable to adjust dimming of the electrochromic mirror reflective element and (ii) a serializer;
an electronic control unit (ECU) disposed at the vehicle remote from the vehicular interior electrochromic rearview mirror assembly;
wherein, with the vehicular interior electrochromic rearview mirror assembly mounted at the interior portion of the interior cabin of the vehicle, the mirror head is electrically connected to the ECU via a coaxial cable;
wherein the coaxial cable comprises the only electrical connection between the vehicular interior electrochromic rearview mirror assembly and the ECU;
wherein image data captured by the cabin monitoring camera is transferred to the ECU via the coaxial cable;
wherein the ECU comprises electronic circuitry and associated software, and wherein the electronic circuitry of the ECU comprises an image processor operable to process image data transferred to the ECU;
wherein the reflectivity-dimming circuitry adjusts dimming of the electrochromic mirror reflective element responsive to receiving a control signal, and wherein, with the vehicular interior electrochromic rearview mirror assembly mounted at the interior portion of the interior cabin of the vehicle, the control signal is transferred from the ECU to the reflectivity-dimming circuitry via the coaxial cable;
wherein the ECU generates the control signal based on at least one selected from the group consisting of (i) a determined level of ambient light at the interior cabin of the vehicle and (ii) determination of glare light incident at the electrochromic mirror reflective element;
wherein image data captured by the cabin monitoring camera and transferred to the ECU via the coaxial cable is processed at the ECU for the at least one selected from the group consisting of (i) determination of the level of ambient light at the interior cabin of the vehicle and (ii) determination of glare light incident at the electrochromic mirror reflective element;
wherein, with the vehicular interior electrochromic rearview mirror assembly mounted at the interior portion of the interior cabin of the vehicle, power is transferred to the mirror head from the ECU via the coaxial cable; and
wherein, with the vehicular interior electrochromic rearview mirror assembly mounted at the interior portion of the interior cabin of the vehicle, image data captured by the cabin monitoring camera and transferred to the ECU via the coaxial cable is processed at the ECU for at least one selected from the group consisting of (i) a driver monitoring function and (ii) an occupant monitoring function.

18. The vehicular cabin monitoring system of claim 17, wherein the control signal comprises a pulse width modulation (PWM) signal.

19. The vehicular cabin monitoring system of claim 17, wherein the mirror head accommodates a printed circuit board (PCB), and wherein the serializer and the reflectivity-dimming circuitry are disposed at the PCB.

20. The vehicular cabin monitoring system of claim 17, wherein the mirror head accommodates a near infrared light emitter, and wherein, with the vehicular interior electrochromic rearview mirror assembly mounted at the interior portion of the interior cabin of the vehicle, the near infrared light emitter is electrically operable to emit near infrared light that illuminates at least a portion of the interior cabin of the vehicle, and wherein the cabin monitoring camera is operable to capture image data representative of near infrared light reflected from objects within the interior cabin of the vehicle, and wherein, responsive to processing image data captured by the cabin monitoring camera and transferred to the ECU via the coaxial cable at the ECU, the vehicular cabin monitoring system adjusts operation of the near infrared light emitter to adjust near infrared light emitted by the near infrared light emitter, and wherein cabin monitoring control signals are transferred from the ECU to the mirror head via the coaxial cable to adjust operation of the near infrared light emitter.
